(19) United States
(12) Patent Application Publication
(10) Pub. No.: US 2012/0114958 A1
(43) Pub. Date: May 10, 2012

(54) FILM WITH A METAL RECEIVING LAYER HAVING HIGH METAL ADHESION AND METHOD OF MAKING SAME

(76) Inventors: Kwangjin Song, Pittsford, NY (US); George F. Cretekos, Farmington, NY (US); Michael J. Bader, Fairport, NY (US)

(21) Appl. No.: 13/320,690

(22) PCT Filed: Apr. 7, 2010
(86) PCT No.: PCT/US2010/030195

§ 371 Date: Jan. 16, 2012

Related U.S. Application Data
(60) Provisional application No. 61/180,619, filed on May 22, 2009.

(51) Int. Cl. B32B 15/085; C08L 23/16; C08L 23/20; C08L 23/06; C08L 29/04; B29C 47/06; C08L 23/12; C08L 31/06; B82Y 30/00

(52) U.S. Cl. 428/457; 524/582; 524/570; 524/579; 524/559; 524/585; 524/557; 264/210.1; 427/296; 977/773

(57) ABSTRACT

This disclosure relates to a film including a metal receiving layer having at least 15 wt. % of oriented lamellar crystals of a polymer, wherein the oriented lamellar crystals of the polymer have an average thickness in a range from about 1.0 nm to 25 nm as measured by transmission electron microscopy (TEM).

### CROSS-REFERENCE TO RELATED APPLICATIONS

This application claims priority from U.S. Provisional Application Ser. No. 61/180,619, filed May 22, 2009, the contents of which are incorporated by reference in their entirety.

### FIELD OF THE INVENTION

This invention relates to a film containing at least one metal receiving layer and a process for manufacturing such film. The metal receiving layer comprises a polymer having oriented lamellar crystals with an average thickness in a range of 1.0 nm to 25 nm.

### BACKGROUND OF THE INVENTION

Surfaces of a polyolefin film are generally inactive and thus produce poor adhesion to polar substrates or metals. To improve metal adhesion, polyolefin films are often treated with corona, flame or plasma. Treated surfaces improve metal adhesion. However, the level of this improvement may not be sufficient for some practical applications. Furthermore, metallized polyolefin films often craze during the converting process because of poor metal adhesion, excess heat and/or applied stress. Crazing degrades substantially the optical and barrier properties of a film.

U.S. Pat. Nos. 3,674,536; 4,357,383; 4,345,005; 4,508,786; 4,522,887; 4,888,237; 5,922,471; 6,033,786; 5,153,074; 5,194,318; 5,958,566; 6,190,760; 6,773,818; 6,790,524; 6,916,526; and U.S. Patent Application No. 20070292682 disclose various compositions for metal receiving layer. However, there is still a need to develop a metallized film having good metal adhesion, sufficient barrier properties and low metal crazing during the extrusion lamination and packaging processes.

### DESCRIPTION OF FIGURES

FIG. 1 shows the transmission electron microscopy (TEM) picture of the metal receiving layer of Example 11 that comprises a cross-hatched lamellar structure with lamellar crystals having an average thickness about 12 nm and oriented parallel and perpendicular to the normal direction.

FIG. 2 shows the TEM picture of the metal receiving layer of Example 4, which consists essentially of row nucleated lamellar crystals having an average thickness about 8.0 nm.

FIG. 3 shows the TEM picture of the metal receiving layer of Example 9, which comprises a fiber-network like lamellar structure having an average thickness about 10.0 nm.

### SUMMARY OF THE INVENTION

This disclosure relates to a film comprising a metal receiving layer having at least 15 wt. % of oriented lamellar crystals of a polymer, wherein the oriented lamellar crystals of the polymer have an average thickness in a range from about 1.0 nm to 25 nm as measured by TEM. In particular, this invention relates to a multi-layer metallized biaxially oriented polypropylene (BOPP) film having substantially improved metal adhesion and barrier properties.

In other embodiments, this disclosure relates to a method of making a film of this disclosure, the method comprising:
a. extruding a composition comprising a polymer through a sheet-forming die to form a sheet;
b. casting the sheet onto a chill roll at a cooling rate of 30.0° C./s or greater; and
c. orienting the sheet in machine direction (MD), transverse direction (TD) or both.

### DETAIL DESCRIPTION OF THE INVENTION

This disclosure relates to a film comprising a metal receiving layer having at least 15 wt. % of oriented lamellar crystals of a polymer, wherein the oriented lamellar crystals of the polymer have an average thickness in a range from about 1.0 nm to 25 nm as measured by TEM.

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the disclosure will refer to any one or more of the appended claims, including their equivalents, and elements or limitations that are equivalent to those that are recited. Any reference to the “invention” may refer to one or more, but not necessarily all, of the inventions defined by the claims.

As used herein, the term “monomer” is a small molecule that may become chemically bonded to other monomers to form a polymer. Examples of monomers include olefinic monomers, such as, ethylene, propylene, butylenes, 1-hexene, styrene, and 1-octene.

As used herein, the term “polymer” refers to the product of a polymerization reaction, and is inclusive of homopolymers, copolymers, terpolymers, etc.

As used herein, unless specified otherwise, the term “copolymer(s)” refers to polymers formed by the polymerization of at least two different monomers. For example, the term “copolymer” includes the copolymerization reaction product of propylene and an alpha-olefin (α-olefin), such as ethylene. However, the term “copolymer” is also inclusive of, for example, the copolymerization of a mixture of more than two monomers, such as, ethylene-propylene-butene.

As used herein, weight percent (“wt. %”), unless noted otherwise, means a percent by weight of a particular component based on the total weight of the mixture containing the component. For example, if a mixture or blend contains three grams of compound A and one gram of compound B, then the compound A comprises 75 wt. % of the mixture and the compound B comprises 25 wt. %. As used herein, parts per million (ppm), unless noted otherwise, means parts per million by weight.

### Metal Receiving Layer

The metal receiving layer as used herein means a receiving layer that accepts a metal (i.e., not a layer comprises metal). In some preferred embodiments, the metal receiving layer is coated with another layer of metal via vacuum deposition of metals, such as, Al, Au, Ag, Cu, Cr, or any combination thereof.

The metal receiving layer comprises at least one polymer. Preferably the metal receiving layer comprises at least 15 wt. % to 100.0 wt. % of a polymer. In some embodiments, the polymer useful for the metal receiving layer is at least one of polymer of olefin, such as polypropylene, propylene-ethylene copolymer, propylene-butene copolymer, and ethylene vinyl alcohol copolymers.

In some embodiments, the polymer of olefin is polypropylene. Suitable polypropylenes include polypropylene homopolymers (hPPs), any propylene based co- or ter-polymers or combinations thereof. Suitable polypropylene homopolymers include isotactic polypropylene (iPPs) with isotacticity greater than or equal to 80.0%, syndiotactic polypropylene (sPP) with isotacticity less than or equal to 30.0%, and combinations thereof. Suitable propylene based co- or ter-polymers are propylene based co- or ter-polymers having a propylene content of greater than or equal to 60.0 wt. %. Such copolymers include ethylene-propylene copolymer, propylene-butene copolymers, ethylene-propylene-butene terpolymer, and combinations thereof. In some embodiments, polypropylenes useful for this disclosure have a melt flow rate (MFR) of less than or equal to 10.0 g/10 min at 230.0° C. and 2.16 kg measured by ASTM D1238.

In other embodiments, the polymer of olefin is high density polyethylenes (HDPEs) having melt index (MI) less than or equal to 6.0 g/10 min at 190.0° C. and 2.16 kg measured by ASTM D 1238 method.

In other embodiments, the ethylene vinyl alcohol copolymers (EVOHs) have a vinyl alcohol content of less than or equal to 80.0 wt. % and MI of less than or equal to 8.0 g/10 min at 190.0° C. and 2.16 kg measured by ASTM D1238.

In some embodiments, the polymer of the metal receiving layer has at least 15 wt. %, preferably at least 20.0 wt. %, more preferably at least 30.0 wt. %, even more preferably at least 40.0 wt. %, yet even more preferably at least 50.0 wt. %, and most more preferably at least 60.0 wt. %, of oriented lamellar crystals, as measured by differential scanning calorimetry (DSC), wherein the oriented lamellar crystals of the polymer have an average thickness in a range from about 1.0 nm to about 25 nm, preferably from about 2.0 nm to about 20.0 nm, more preferably from about 5.0 nm to about 15 nm, as measured by TEM.

In other embodiments, the metal receiving layer has less than 10.0 wt. %, preferably less than 5 wt. % spherulitic polymeric crystals based on the total weight of the polymer in the metal receiving layer. In other embodiments, the metal receiving layer less than 20.0 wt. %, preferably less than 10.0 wt. % un-oriented lamellar polymeric crystals based on the total weight of the polymer in the metal receiving layer.

In yet other embodiments, the polymer of the metal receiving layer comprises a smectic-like structure. In a preferred embodiment, the metal receiving layer consists essentially of a smectic-like structure. The term “smectic-like structure” as used herein means a semi-crystalline polymer texture that consists of alternating amorphous and crystalline phases, wherein the crystalline phase consists essentially of poorly ordered, oriented thin lamellar crystals. A smectic phase (or mesophase) is defined as an intermediate molecular order between the amorphous and crystalline phases.

In some embodiments, the film is uniaxially oriented in the MD, TD or biaxially oriented in the MD and TD. In some aspects, the MD uniaxially or biaxially oriented film has a heat shrinkage ratio in a range from about 3.5% to about 15% at 135° C., preferably from about 5.0% to about 12% at 135° C., more preferably from about 6.0% to about 10.0% at 135° C. in the MD.

In further embodiments, the film of this disclosure further comprises at least one of a core layer, a first tie layer, a second tie layer and a sealant layer.

The film of this disclosure may further comprise a metal layer deposited on the metal receiving layer to form a metallized film. The metallized film of this disclosure has metal pickoff less than 20.0%, preferably less than or equal to 10.0%, more preferably less than or equal to 5%; OTR less than or equal to 30.0 cc/m²/day, preferably less than or equal to 15 cc/m²/day, more preferably less than or equal to 10.0 cc/m²/day; WVTR less than or equal to 0.3 g/m²/day, preferably less than or equal to 0.2 g/m²/day, more preferably less than or equal to 0.1 g/m²/day, even more preferably less than or equal to 0.09 g/m²/day; crazes in extrusion lamination less than or equal to 10.0%, preferably less than or equal to 5.0%; and a ratio of OTR and WVTR increases from before to after 10.0% stretch of the metallized film, i.e., the degree of barrier degradation at 10.0% stretch, less than or equal to 10.0.

### Core Layer

The core layer of a multilayered film is commonly the thickest layer and provides the foundation of the film. The core layer may comprise a polyolefin, such as polypropylene or polyethylene with or without cavitating agent.

The core layer may further comprise one or more additives. Preferred additives for the core layer include, but are not limited to, hydrocarbon resin(s), hydrocarbon wax(es), opacifying or coloring agent(s), slip additive(s), and cavitating agent(s).

### Orientation

The film may be uniaxially or biaxially oriented. Orientation in the direction of extrusion is known as machine direction orientation. Orientation perpendicular to the direction of extrusion is known as transverse direction orientation. Orientation may be accomplished by stretching or pulling a film first in the MD, optionally followed by the TD. Orientation may be sequential or simultaneous, depending upon the desired film features.

In some embodiments, the film is stretched in the machine direction (MD) by 5.0 to 10.0 times at temperatures (T_{MDO}) 140.0° C. or lower and in the transverse direction (TD) by 5.0 to 10.0 times at temperatures (T_{TDO}) 170.0° C. or lower. A relaxation ratio (ε) in the TD is 5.0% or lower.

Blown films may be oriented by controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are biaxially oriented polypropylene (BOPP) tenter process and LISIM technology.

### Surface Treatment

One or both of the outer exposed surfaces of the film may be surface-treated to increase the surface energy of the film to render the film receptive to metallization, coatings, printing inks, and/or lamination. The surface treatment can be carried out according to one of the methods known in the art, such as flame or plasma. Preferably, the metal receiving layer of the film is plasma treated prior to the metallization.

### Metallization

The metal receiving layer of the film may be metallized using conventional methods, such as vacuum deposition of a metal layer such as aluminum, copper, silver, chromium, or mixtures thereof. In a preferred embodiment, the metallized layer metal is aluminum.

### Manufacturing Process

In some embodiments, this disclosure relates to a method of making a film of this disclosure, the method comprising:
a. extruding a composition comprising a polymer through a sheet-forming die to form a sheet;
b. casting the sheet onto a chill roll at a cooling rate of 30.0° C./s or greater; and
c. orienting the sheet in MD, TD or both.

In other embodiments, this disclosure relates to a process for manufacturing multi-layer PP film that includes the steps of co-extrusion of polymer melts through film forming dies, casting of the co-extrudates, monoaxial or biaxial stretching of the film, and relaxation of the oriented film.

The multilayer film is co-extruded at temperatures less than or equal to 280.0° C. The co-extruded sheets are quenched at a cooling rate greater than or equal to 30.0° C./s, measured by the temperatures of the sheet surfaces before and after cooling and the residence time of the cooling process. The cooling may be conducted with a chill roll and/or a water bath. Prior to orientation, a polypropylene-based metal receiving layer has nodular crystals having an average domain size below 30.0 nm as measured by TEM, preferably consisting essentially of nodular crystals, having an average domain size below 30.0 nm as measured by TEM. The metal receiving layer of the sheet has a density of 0.8950 g/cm³ or lower measured according to ASTM D 792 method and a non-crystalline halo or smectic reflections at 2θ around 14.8° and/or 21.5° measured by grazing-incidence X-ray diffraction (GIXD).

In some embodiments, the metal receiving layer of the film made by this inventive process may comprise or consist essentially of smectic phases or lamellar crystals, having an average domain size or thickness less than or equal to 25 nm as measured by TEM. In other embodiments, the metal receiving layer of the film by the process of this disclosure may have monoclinic a lamellar phase having crystalline reflections at 2θ around 14.5°, 17.1° and/or 18.6° measured by GIXD.

### Industrial Application

In some embodiments, the film of this disclosure may be used in flexible packaging and labeling applications.

Films according to the present disclosure may further be treated for its intended use such as by coating, printing, slitting, or other converting methods. Preferred methods comprise co-extruding, then casting and orienting the film.

The present disclosure will be explained in more detail referring to Examples below without intention of restricting the scope of the present disclosure.

### Test Procedures and Materials Used

The properties of the films in the Examples (“Ex”) and Comparative Examples (“Cx”) were variously measured by the following test methods.

Density of the metal receiving layer was measured by measuring weight and volume of the sample, in accordance with ASTM D792. For the cast sheet, the samples were cryo-faced at −130.0° C. and then cut parallel to the surface at thicknesses of 100 μm or thinner with a cryo-microtome.

The average domain sizes or thicknesses of smectic nodules and lamellar crystals were measured with a FEI Tecnai G² F20ST transmission electron microscopy (TEM) operating at high-angle annular dark field scanning TEM mode (HAADF-STEM). The samples were cryo-faced at −130.0° C. and then stained with RuO₄ for 6 hours. Thin cross-sections of the stained sample were cut with a cryo-microtome and imaged by TEM.

Crystalline melting temperature (Tₘ) and the heat of fusion (ΔH_{f}) were measured with differential scanning calorimetry (DSC) at a heating rate of 10.0° C./min according to ASTM D3418. The crystallinity (Xc) was computed with the following equation:

Xc(%)=(ΔH_{f}/ΔHₒ)×100

where ΔHₒ is the heat of fusion of 100.0% crystalline polypropylene.

Heat shrinkage ratio in the MD (S_{MD}) was measured at 135° C., according to ASTM D1204. Units are reported as percentage (%) change from the original dimension.

The X-ray diffraction patterns of a film surface were obtained by grazing-incidence X-ray diffraction (GIXD). Scintag X2 Powder Diffractometer was used with Cu Kα radiation (λ=0.1542 nm) at 40 kV and 50 mA. 2θ scanning was conducted in the range of 4° to 45° at an incident angle around 0.05°.

Oxygen transmission rate (OTR) was measured by using a Mocon Oxtran 2/20 unit in accordance with ASTM D3985 at 23° C. and 0% relative humidity (RH), and moisture vapor transmission rate (WVTR) by using a Mocon Permatran 3/31 unit in accordance with ASTM F1249 at 37.8° C. and 90.0% RH. For the measurement of barrier degradation property, the test films were stretched up to 10.0% with an Instron tensile tester, held for a second, and then released from the holding grips. OTR and WVTR were then measured for variously stretched samples. The degree of barrier degradation is expressed as a ratio of OTR or WVTR increases from before to after 10.0% stretch, i.e., the degree=OTR (or WVTR) before stretch/OTR (or WVTR) after 10.0% stretch.

Optical density (OD) was measured using a Tobias Associates model TBX transmission densitometer and Macheth Model TD903 and TD932, according to ANSI/NAPM IT2.19.

Metal pickoff was measured by removing a strip of 1-inch wide 3M 610 Scotch® tape adhered to the metallized surface of a multilayer film. The amount of metal removed was rated qualitatively as follows: scale 1.0 means less than or equal to 5.0% metal removed, scale 2.0 means more than 5.0 to less than or equal to 10.0% metal removed, scale 3.0 means more than 10.0 to less than or equal to 20.0% metal removed, scale 4.0 means more than 20.0 to less than or equal to 50.0% metal removed, and scale 5.0 means more than 50.0% metal removed. Scales 1 or 2 are indication of low metal pickoff.

The metallized layer of the film was extrusion laminated with low density polyethylene (LDPE) at 320.0° C. to an 18 nm BOPP film substrate. The weight of LDPE melt was 4.54 Kg/ream that hit directly onto the metallized layer unwound from the primary unwind at 47.7 Kg tension. The BOPP film substrate was on the secondary unwind. Crazing resistance (CZ) of the metallized films was measured visually by measuring the amount of crazes produced as follows: scale 1.0 means less than or equal to 5.0% crazes produced, scale 2.0 means more than 5.0 to less than or equal to 10.0% crazes produced, scale 3.0 means more than 10.0 to less than or equal to 20.0% crazes produced, scale 4.0 means more than 20.0 to less than or equal to 50.0% crazes produced, and scale 5.0 means more than 50.0% crazes produced. Scales 1 or 2 are indication of low metal craze.

The bond strength of the laminated films was measured with a Scintag tensile tester at the 90° angle testing mode, according to ASTM D1876. A film sample was aged at room condition for 7 days. Specimens were 2.54 cm wide and 15.2 cm long. Both surfaces of the laminated film were carefully taped by 2.54 cm wide 3M 610 Scotch® tape to prevent film tear during the peeling test. The bond strength was then measured by delaminating the aged sample by pulling the tape on the leading edge.

Table 1 shows polymers used in the Examples.

TABLE 1
Polymers Used in the Examples

| | | | | MFR (g/10 |
|---|---|---|---|---|
| Name | Specification | Manufacturer | Tₘ (° C.) | min) |
| PP4712 | Mini-random PP (mr-PP) | ExxonMobil Chemical Co. | 160 | 2.8 |
| PP4612 | Homo PP (h-PP) | ExxonMobil Chemical Co. | 160 | 2.8 |
| PP1024 | Homo PP (h-PP) | ExxonMobil Chemical Co. | 160 | 12.5 |
| PP4772 | Mini-random PP (mr-PP) | ExxonMobil Chemical Co. | 161 | 1.6 |
| PP4052 | High Crystalline PP (HCPP) | ExxonMobil Chemical Co. | 165 | 2.0 |
| PP9112 | Ethylene-Propylene Copolymer (EP) | ExxonMobil Chemical Co. | 145 | 2.1 |
| RC1601 | Propylene-Butene Copolymer (PB) | Basell Co. | 150 | 7.0 |
| TD908BF | Ethylene-Propylene-Butene | Borealis Co. | 148 | 7.5 |
| | Terpolymer (EPB) | | | |
| XPM 7794 | Ethylene-Propylene-Butene | Japanese Polypropylene Co. | 122 | 5.0 |
| | Terpolymer (EPB) | | | |
| Admer1179 | Maleated PP | Mitsui Chemical Co. | 160 | 3.8 |
| XM6030A | High Density PE (HDPE) | Equistar Lyondell Co. | 130 | MI = 2.0 |
| Eval 176G | Ethylene Vinyl Alcohol Copolymer | Kuraray Co. | 160 | MI = 6.9 |
| | (EVOH) | | | |

### Examples and Comparative Examples

All Examples and all Comparative Examples were five layer films made by co-extrusion using five separate extruders having a total output of about 230 Kg/hour. The extrudates were quenched using a chill roll and a water bath. The films were subsequently biaxially stretched in the MD using the combination of slow and fast speed roller and in the TD with the tenter frame; and then relaxed in the TD at a preset ratio by the width of the tenter frame rails. The relaxation ratio (ε) was computed with the following equation:

ε(%)=100×(Width of the tenter frame rail at the start of TD annealing zone−Width of the tenter frame rail at the end of TD stretch zone)/(Width of the tenter frame rail at the end of TD annealing zone)

The biaxially stretched films were then treated by flame and/or plasma to surface energy of 35 dyne/cm or greater, which subsequently metallized by vacuum deposition of aluminum to an optical density (OD) about 2.7.

Table 2 shows a representative film structure used in the Examples and Comparative Examples. The composition of the metal receiving layer for all Examples and Comparative Examples are listed in Table 3. All Examples and Comparative Examples had PP4612 for both tie layers (except Ex 12 and Cx 8 which used Admer 1179 as tie layer adjacent to the metal receiving layer), PP4612 for core layer and XPM7794 for sealant skin layer.

TABLE 2
Representative Structure of 5 Layer Example Films

| | Composition | Polymer | Layer |
|---|---|---|---|
| Layer | (%) | Resin | Thickness (μm) |
| Metal Receiving Layer | See Table 3 | See Table 3 | 1.0 |
| Tie | 100 | PP4612 | 3.0 |
| Core | 100 | PP4612 | 10.0 |
| Tie | 100 | PP4612 | 3.0 |
| Sealant Skin | 100 | XPM7794 | 1.0 |

Table 3 below shows the metal receiving layers and process conditions used in the Examples and Comparative Examples, wherein T_{EXT} represents the set temperature of extruder barrels; T_{CW} represents the set temperatures of cast roll and water bath; Rate represents the cooling rate of the metal receiving layer surfaces in degree per second (° C./s); MDX represents the MD stretch ratio; T_{MDO} represents the MD stretch temperature for the stretch rolls; TDX represents the TD stretch ratio; T_{TDO} represents the TD stretch temperature of the tentor oven; and ε represents the relaxation ratio.

TABLE 3
Metal receiving layers and Process Conditions Used in the Examples

| | | Extrusion | CAST | | MDO | | TDO | | |
|---|---|---|---|---|---|---|---|---|---|
| | Metal receiving | T_{EXT} | T_{CW} | Rate | | T_{MDO} | | T_{TDO} | ε |
| Film | layer | (° C.) | (° C.) | (° C./s) | MDX | (° C.) | TDX | (° C.) | (%) |
| Ex 1 | PP4712 | 270 | 10 | 86.7 | 5.0 | 100 | 8.0 | 155 | 0 |
| Ex 2 | PP4712 | 270 | 30 | 120 | 5.5 | 110 | 8.0 | 160 | 2 |
| Ex 3 | PP4612 | 270 | 20 | 83.3 | 5.2 | 100 | 8.0 | 157 | 0 |
| Ex 4 | PP4772 | 270 | 10 | 104 | 5.0 | 95 | 9.0 | 160 | 0 |
| Ex 5 | PP4052 | 270 | 10 | 86.7 | 5.0 | 120 | 8.0 | 163 | 2 |
| Ex 6 | PP9112 | 250 | 20 | 115 | 5.3 | 95 | 9.0 | 155 | 2 |
| Ex 7 | RC1601 | 250 | 20 | 115 | 5.3 | 95 | 9.0 | 155 | 2 |
| Ex 8 | TD908BF | 250 | 20 | 115 | 5.3 | 95 | 9.0 | 155 | 2 |
| Ex 9 | XPM7794 | 250 | 20 | 115 | 5.3 | 95 | 9.5 | 155 | 2 |
| Ex 10 | 50/50% | 250 | 20 | 115 | 5.3 | 100 | 9.0 | 158 | 2 |
| | PP4712/TD908BF | | | | | | | | |
| Ex 11 | XM6030A | 250 | 20 | 115 | 5.1 | 110 | 8.0 | 160 | 0 |
| Ex 12 | Eval 176G | 230 | 10 | 122 | 5.1 | 110 | 8.0 | 160 | 0 |
| Cx 1 | PP1024 | 250 | 50 | 27.9 | 5.0 | 110 | 9.0 | 170 | 10 |
| Cx 2 | PP4712 | 260 | 50 | 27.2 | 5.0 | 120 | 9.0 | 170 | 10 |
| Cx 3 | PP4052 | 260 | 50 | 27.2 | 4.8 | 120 | 8.0 | 175 | 5.5 |
| Cx 4 | RC1601 | 230 | 60 | 23.5 | 5.0 | 125 | 9.0 | 170 | 10 |
| Cx 5 | TD908BF | 230 | 60 | 23.5 | 5.0 | 125 | 9.0 | 170 | 10 |
| Cx 6 | XPM7794 | 230 | 60 | 23.5 | 5.0 | 125 | 9.0 | 170 | 10 |
| Cx 7 | XM6030A | 230 | 60 | 23.5 | 5.3 | 120 | 8.0 | 170 | 5.5 |
| Cx 8 | Eval 176G | 210 | 50 | 27.6 | 5.3 | 120 | 8.0 | 170 | 5.5 |

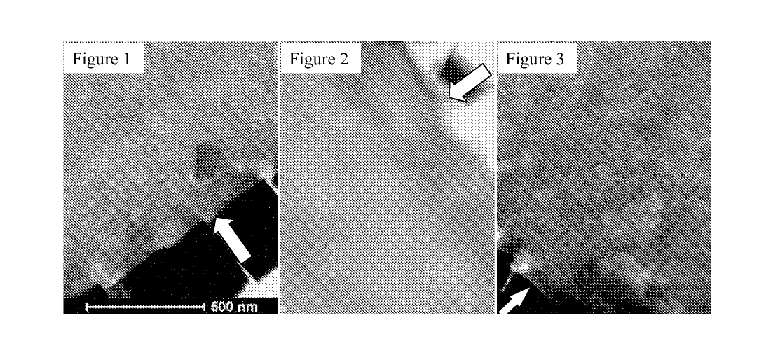

Figures show TEM images of the metal receiving layer, wherein an arrow indicates normal to the surface and dark rectangles are TEM artifacts. Bright and dark regions represent respectively crystalline and non-crystalline phases. It indicates that the chain axes of both non-crystalline and crystalline phases are preferentially oriented in the plane of the film. The scale bar in FIG. 1 applies to all three Figures.

FIG. 1 shows the metal receiving XM6030A layer of Example 11 that consists of a cross-hatched lamellar structure. The lamellar crystals have an average thickness about 12 nm and orient themselves parallel and perpendicular to the normal direction. FIG. 2 shows the metal receiving PP4772 layer of Example 4, which consists dominantly of row nucleated lamellar crystals having an average thickness about 8 nm. FIG. 3 shows the metal receiving XPM7794 layer of Example 9, which consists of a fiber-network like lamellar structure having an average thickness about 10 nm.

Table 4 shows the properties of the Examples and Comparative Examples, wherein 0, 5.0 and 10.0% strains represent % stretch of the laminated metallized films. Samples at 0% strain represent as-laminated films without stretch.

TABLE 4
Properties of the Example Films

| | | | | | | Laminated Metallized Film | | | | | | | |
|---|---|---|---|---|---|---|---|---|---|---|---|---|---|
| | Biaxial Film | | Metallized Film | | | | | OTR at Stretch | | | WVTR at -Stretch | | |
| | S_{MD} | t_{L, S} | Pick- | OTR | WVTR | | σ_{BOND} | (cc/m²/d) | | | (g/m²/d) | | |
| Film | (%) | (nm) | off | (cc/m²/d) | (g/m²/d) | CZ | (g/in) | 0% | 5.0% | 10.0% | 0% | 5.0% | 10.0% |
| Ex 1 | 8.33 | 9 | 1 | 7.1 | 0.05 | 1 | 245 | 6.1 | 11.7 | 18.2 | 0.06 | 0.11 | 0.15 |
| Ex 2 | 7.83 | 10 | 1 | 6.3 | 0.04 | 1 | 306 | 5.2 | 10.6 | 17.0 | 0.07 | 0.12 | 0.14 |
| Ex 3 | 7.67 | 10 | 1 | 5.6 | 0.07 | 1 | 206 | 6.3 | 11.6 | 16.5 | 0.06 | 0.12 | 0.12 |
| Ex 4 | 4.67 | 8 | 1 | 8.2 | 0.05 | 1 | 307 | 8.5 | 12.3 | 16.0 | 0.04 | 0.08 | 0.10 |
| Ex 5 | 7.00 | 10 | 1 | 9.1 | 0.06 | 2 | 177 | 9.4 | 15.7 | 23.2 | 0.07 | 0.09 | 0.14 |
| Ex 6 | 6.67 | 11 | 1 | 6.3 | 0.05 | 2 | 339 | 6.1 | 13.9 | 31.1 | 0.05 | 0.15 | 0.15 |
| Ex 7 | 6.50 | 11 | 1 | 3.2 | 0.03 | 2 | 301 | 3.1 | 11.7 | 31.6 | 0.08 | 0.21 | 0.25 |
| Ex 8 | 8.83 | 8 | 1 | 7.5 | 0.09 | 2 | 330 | 7.3 | 14.7 | 19.1 | 0.09 | 0.11 | 0.18 |
| Ex 9 | 6.67 | 10 | 1 | 8.9 | 0.06 | 1 | 262 | 7.6 | 10.9 | 21.2 | 0.04 | 0.13 | 0.16 |
| Ex 10 | 6.33 | 10 | 1 | 5.3 | 0.05 | 1 | 411 | 5.1 | 9.1 | 22.0 | 0.06 | 0.16 | 0.21 |
| Ex 11 | 6.15 | 12 | 1 | 10.5 | 0.04 | 1 | 547 | 9.6 | 23.2 | 29.8 | 0.05 | 0.15 | 0.20 |
| Ex 12 | 5.50 | 11 | 1 | 0.20 | 0.10 | 1 | 291 | 0.20 | 0.22 | 0.25 | 0.11 | 0.17 | 0.22 |
| Cx 1 | 2.67 | 24 | 3 | 46.5 | 0.91 | 5 | 101 | 46.5 | 113 | 565 | 1.10 | 4.21 | 12.7 |
| Cx 2 | 2.50 | 25 | 3 | 31.2 | 0.20 | 4 | 98 | 31.2 | 69.8 | 326 | 0.20 | 2.35 | 10.4 |
| Cx 3 | 2.82 | 22 | 3 | 29.8 | 0.28 | 4 | 95 | 29.8 | 57.5 | 301 | 0.30 | 1.51 | 9.6 |
| Cx 4 | 3.01 | 21 | 1 | 12.6 | 0.15 | 5 | 92 | 11.2 | 83.1 | 665 | 0.15 | 1.24 | 5.74 |
| Cx 5 | 2.55 | 20 | 1 | 11.5 | 0.18 | 5 | 90 | 11.5 | 76.8 | 826 | 0.12 | 1.52 | 6.25 |
| Cx 6 | 3.12 | 21 | 1 | 13.3 | 0.14 | 5 | 85 | 10.4 | 75.5 | 701 | 0.11 | 2.01 | 8.21 |
| Cx 7 | 3.33 | 22 | 1 | 15.1 | 0.11 | 5 | 138 | 15.1 | 74.1 | 878 | 0.12 | 0.61 | 4.73 |
| Cx 8 | 2.97 | 22 | 1 | 0.25 | 0.24 | 5 | 129 | 0.25 | 1.19 | 16.4 | 0.28 | 1.48 | 4.49 |

As demonstrated above in the various Examples, the multilayer films of the instant invention possess various outstanding properties in metal adhesion, resistance of the metal layer to crazing or crack, barrier properties, as well as barrier retention property, compared to the comparative films.

Thus, while there have been described what are presently believed to be the preferred embodiments of the invention, those skilled in the art will realize that various changes and modifications may be made to the invention without departing from the spirit of such invention. All such changes and modifications which fall within the scope of the invention are therefore intended to be claimed.

1. A film comprising a metal receiving layer having at least 15 wt. % of oriented lamellar crystals of a polymer, wherein said oriented lamellar crystals of said polymer have an average thickness in a range from about 1.0 nm to 25 nm as measured by transmission electron microscopy (TEM).

2. The film of claim 1, wherein said metal receiving layer comprises at least 20.0 wt. % of oriented lamellar crystals of said polymer having an average thickness in a range from about 2.0 nm to 20.0 nm as measured by transmission electron microscopy (TEM).

3. The film of claim 1, wherein said lamellar crystals have an average thickness in the range from about 5.0 nm to about 15 nm as measured by transmission electron microscopy (TEM).

4. The film of claim 1, wherein said metal receiving layer consists essentially of a smectic-like structure.

5. The film of claim 1, wherein said film is uniaxially oriented in the MD or TD.

6. The film of claim 1, wherein said film is biaxially oriented in the MD and TD.

7. The film of claim 5, wherein said film has a heat shrinkage ratio of 3.5% to 15% in the MD.

8. The film of claim 5, wherein said film has a heat shrinkage ratio of 5.0% to 12% in the MD.

9. The film of claim 5, wherein said film has a heat shrinkage ratio of 6.0% to 10.0% in the MD.

10. The film of claim 1, further comprising at least one of a core layer, a first tie layer, a second tie layer, and a sealant layer.

11. The film of claim 1, wherein said polymer is at least one of polymer of olefin, copolymer of olefins, and polyester.

12. The film of claim 11, wherein said polymer of olefin is polypropylene.

13. The film of claim 1, further comprising a metal layer deposited on said metal receiving layer.

14. A method of making film comprising:
a. extruding a composition comprising a polymer through a sheet-forming die to form a sheet;
b. casting said sheet onto a chill roll at a cooling rate of 30.0° C./s or greater; and
c. orienting said sheet in at least one of MD, TD, or both.

15. The method of claim 14, further comprising:
d. treating the surface of said film with flame, plasma or both; and
e. metallizing said film.

16. A film made by the method of claim 15.
